(19) United States
(12) Patent Application Publication
(10) Pub. No.: US 2023/0381729 A1
(43) Pub. Date: Nov. 30, 2023

(54) CONICAL ROTATING SPIN CONTACTOR

(71) Applicant: NuMat Tec.comhnologies, Inc, Skokie, IL (US)

(72) Inventors: Glenn McPherson Tom, Bethany Beach, DE (US); Nicolaas Vermeulen, Chicago, IL (US); Anton H. Nguyen, Chicago, IL (US); Javan L. Whitney-Warner, Chicago, IL (US)

(73) Assignee: NuMat Technologies, Inc., Skokie, IL (US)

(21) Appl. No.: 18/199,783

(22) Filed: May 19, 2023

Related U.S. Application Data
(60) Provisional application No. 63/345,870, filed on May 25, 2022.

(51) Int. Cl. B01J 8/22; B01D 15/18; B01J 8/34; B01J 8/08; B01J 8/38

(52) U.S. Cl. CPC B01J 8/226; B01D 15/1807; B01J 8/34; B01J 8/085; B01J 8/386; B01J 2208/00548

(57) ABSTRACT

A spin contactor is provided for contacting a particulate with a fluid. The spin contactor has a containment section that may contain the particulate, a fluid inlet, and a fluid outlet. The containment section comprises an upper particulate separator, a lower particulate separator, and a conical wall. In most cases, the spin contactor includes a shaft to be operatively coupled to a means for spinning the spin contactor. The fluid is drawn upwardly through the fluid inlet to contact the particulate and then expelled through the fluid outlet. A process of treating a fluid composition is provided by sending the fluid composition through the spin contactor comprising particulates.

### CROSS-REFERENCE TO RELATED APPLICATIONS

This application claims priority from U.S. Provisional Application No. 63/345,870, filed May 25, 2022, which is incorporated herein in its entirety.

### FIELD

The present disclosure relates to a conical spin contactor for performing, by means of solid particles, a biological or chemical transformation, or physical or chemical trapping from, or release of agents to, a fluidic media. The disclosure further refers to a process for performing such an operation using a conical spin contactor.

### BACKGROUND

To get the best utilization of heterogenous catalysts and scavengers, it is necessary for the heterogenous rates of reaction and adsorption to be as high as possible. For reaction rates to be sufficient, it is preferred for smaller particles to be used. For example, when a test scavenger was exposed to a bulky molecule of palladium dichloride bis(triphenylphosphine), it was found that a scavenger under 150 microns in particle size diameter provided for rapid removal of palladium species. However, a 700-micron sized scavenger provided a much slower removal of the palladium species.

In conventional packed bed systems, it is necessary to have larger size particles in order to keep pressure drops low. However, the reaction rate is much slower with larger particle size. While smaller particles are desirable, they can be more difficult to contain. One way to deal with this tension is to use materials having a higher density.

A reactor filled with a packed bed of active ingredients spun driven by an external motor has been introduced. This reactor is submerged into a working fluid in a process vessel. As the bed reactor is rotated, liquid is pushed out of the cylinder's porous external wall via centrifugal force and is pulled into the reactor from the top and the bottom. It is believed that operation of this system would require large particles to limit the pressure drop across the packed bed.

### SUMMARY

A spin contactor is provided for contacting a particulate with a fluid. The spin contactor has a containment section containing the solid particulate, a lower fluid inlet, and an upper fluid outlet. The particulate may be a catalyst for catalyzing constituents in the fluid to react or an adsorbent or scavenger for adsorbing constituents in the fluid.

The containment section comprises a first particulate separator, a second particulate separator, and a conical wall. Optionally, the spin contactor includes a shaft to be operatively coupled to a motor for spinning the spin contactor causing fluid to be drawn upwardly through the fluid inlet to contact the particulate in the containment section and then be expelled through the fluid outlet.

Also provided is a process for treating a fluid composition, comprising charging or sending the fluid composition to a spin contactor which comprises a conical wall that defines a volume for containing particulates, rotating the spin contactor at a velocity sufficient to fluidize the particulates within the fluid composition in the defined volume, and contacting the fluid composition with the fluidized particulates to effect a physical or chemical transformation of the fluid composition. The transformed fluid composition is then discharged from the spin contactor while retaining the fluidized particulates in the spin contactor.

### BRIEF DESCRIPTION OF DRAWINGS

FIG. 1 shows a perspective view of a spin contactor with a first particulate separator and a second particulate separator.

FIG. 2 shows a perspective view of a spin contactor with a flow straightener.

FIG. 3 is a perspective view of a spin contactor with blades on a bottom section and baffles on an inner surface.

FIG. 4 shows a perspective view of a spin contactor with an extended bottom section at different levels of submersion.

FIG. 5 shows an elevational view of an embodiment of a containment section of a spin contactor of FIG. 1.

FIG. 6 shows an elevational view of another embodiment of a containment section of a spin contactor of FIG. 1.

FIG. 7 shows an elevational view of another embodiment of a containment section of a spin contactor of FIG. 1.

FIG. 8 shows an elevational view of another embodiment of a containment section of a spin contactor of FIG. 1.

FIGS. 9 and 10 show elevational views of embodiments of a containment section of the spin contactor of FIG. 1 with different cone angles.

FIG. 11 is an exploded elevational view that shows the relationship of the three main components of the spin contactor of FIG. 1.

FIG. 12 is a perspective view of the spin contactor of FIG. 1.

### DETAILED DESCRIPTION

It has now been found that a rotating fluidized bed can efficiently adsorb or desorb species or catalyze reactants in a process vessel. A spin contactor has been designed to work with the small particle size diameters of scavengers and catalysts to achieve enhanced rates of reaction and utilization of these adsorbents and catalysts. The gains provided by the spin contactor enhance the end users' cost of ownership by minimization of the active agents needed, increasing reaction rates, and reducing process costs by simplification of the operation.

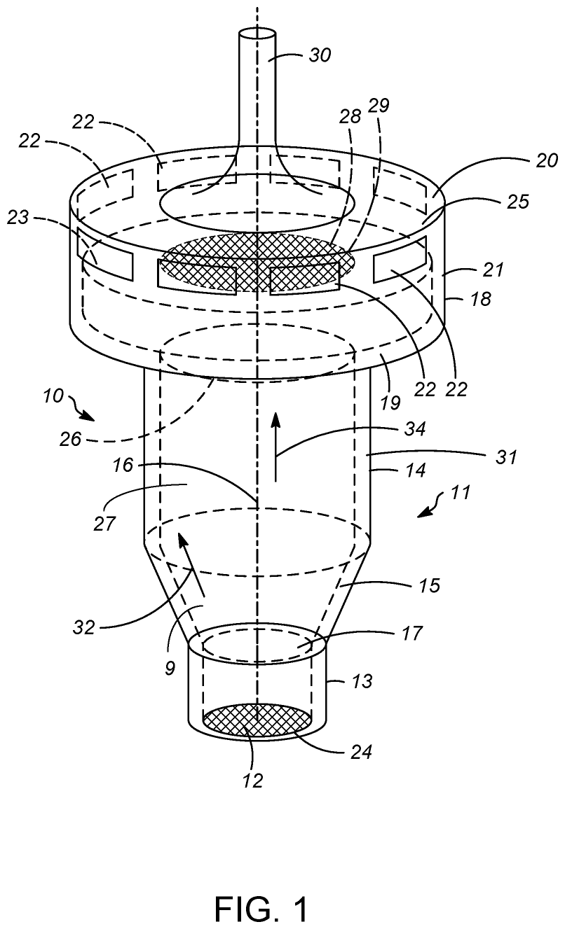

The basic design of a spin contactor 10 shown in FIG. 1 includes a containment section 11 that may be conical or frustoconical in configuration or have a combination of frustoconical and cylindrical portions. The spin contactor 10 of FIG. 1 includes a containment section 11 that comprises a main containment section 14. In an embodiment, the containment section 11 of FIG. 1 may include a cylindrical bottom section 13, and a cylindrical top containment section 18. In FIG. 1, the main containment section 14 comprises a conical wall 15 that defines a conical section 9 comprising an inverted frustum; that is, with the vertex directed downwardly. By conical, frustoconical is also meant, herein. In the embodiment of FIG. 1, the main containment section 14 also includes a cylindrical upper section 27 comprising a cylindrical wall 31. The main containment section 14 may be disposed between the bottom containment section 13 and the top containment section 18. The containment section 11 will contain a volume of fluid during operation which volume may be defined at least in part by the conical wall 15.

A first particulate separator 12 and a second particulate separator 28 constrain particles to remain within the containment section 14. Particulate separators at or near the top and bottom of the containment section 11, respectively, constrain particles, which are also referred to as particulate herein, to remain within the spin contactor 10. When a scavenger, adsorbent or catalyst is added to the spin contactor 10, a first particulate separator 12 and a second particulate separator 28 retain the particles within the containment section 11 of the spin contactor The particulate may be a material that is not reactive with the fluid. FIG. 1 shows an embodiment of the spin contactor having a lower particulate separator 12 and an upper particulate separator 28. In the orientation shown in FIG. 1, the first particulate separator is the lower particulate separator 12, and the second particulate separator is the upper particulate separator 28.

In an embodiment of the spin contactor in FIG. 1, a cylindrical top section 18 is attached or joined to the top of the main containment section 14. At the top of the spin contactor is a solid cover 25 that defines an upper fluid outlet chamber 20 from the containment section 11. The cover 25 may be attached or joined to the top section 18. In the cover 25 one or more fluid discharge outlets 22 are provided in a cylindrical outer wall 21. A partition 23 spans the entire cross section of the top section 18. The upper particulate separator 28 is located near, at or in a fluid outlet 29 in the partition 23 in the top section 18 adjacent to the containment section 11. In the orientation of FIG. 1, the fluid outlet 29 may be at or near a top of the spin contactor 10. The upper particulate separator 28 may be a screen with openings that are smaller than the particles in the containment section 11. The openings allow fluid to pass but are too small to let particulates through. The containment section 11 is provided between the upper particulate separator 28 in the fluid outlet 29 and the lower particulate separator 12. The partition 23 and the upper particulate separator 28 may be integral to the top section 18 or affixed to it. The upper particulate separator 28 and the lower particulate separator 12 in the spin contactor 10 both constrain the particulate to remain within the containment section 11 of the spin contactor.

The top section 18 may be integral with or attached to the main containment section 14, such as by having matching screw threads or other mechanical connectors. The top section 18 may have a lower wall 19. The lower wall 19 may be frustoconical. In FIG. 1, the lower wall 19 has a greater conical angle with respect to a vertical longitudinal axis 16 than the main containment section 14. The cover 20 and the lower wall 19 may be connected by the cylindrical outer wall 21. The top of the cone defines a base cone outlet 26 of the main containment section 14 that is also defined by an opening in the lower wall 19.

The top section 18 may be equipped with a shaft 30. The shaft 30 may be coupled to a motor (not shown) that is employed to spin the spin contactor 10. An associated coupling bushing (not shown) may be employed to couple the shaft 30 to a shaft of the motor.

The conical section 9 can be truncated to define an open cone inlet 17 of the conical wall 15. The diameter of the open cone inlet will affect the pressure drop across the lower particulate separator. The open cone inlet 17 should be large enough to permit adequate flow through the spin contactor 10 but sufficiently small to draw fluid therethrough while spinning at an adequate flow rate to levitate the largest particles in the spin contactor.

The overall inner diameter of the spin contactor will be determined by the desired flow rate of the fluid. The overall height of the spin contactor 10 will be determined by the volumetric flow rate of fluid to be processed and the desired volume of the containment section 11.

A bottom containment section 13 may depend from the bottom of the main containment section 14. The bottom containment section 13 may be cylindrical and be contiguous with the open cone inlet 17 in the bottom of the main containment section 14. The bottom containment section 13 of the spin contactor 10 may attach to the main containment section 14 by matching screw threads or other mechanical connectors onto the bottom of the main containment section 14 or be integral with it. The spin contactor 10 may include a fluid inlet 24. In the orientation of FIG. 1, the fluid inlet 24 may be at or near a bottom of the spin contactor 10. The bottom of the bottom containment section 13 may be open to provide a lower fluid inlet 24 to the containment section 11. The lower particulate separator 12 is adjacent to the containment section and has openings that allow fluid to pass but are too small to let particulates through. The lower particulate separator 12 may be near, in or at the fluid inlet 24. The lower particulate separator 12 may be integral with the bottom containment section 13 or affixed to it.

An external motor may be used to rotate the spin contactor. This motor may be a speed-controlled DC motor that may produce a rotational speed of, for example, about 50 to about 200 rpm. The rotational speed will be variably selected according to the diameter of the spin contactor, the density of the particles, and the particular liquid composition being processed.

The spin contactor 10 is submerged in a vessel containing fluid to be treated. Spinning or rotating the spin contactor 10 at a sufficient rotational velocity draws the liquid from the vessel to enter the lower fluid inlet 24 in the bottom containment section 13 of the spin contactor thus charging fluid to be treated to the spin contactor 10. The fluid fills the containment section 14 of the spin contactor through the cone inlet 17 as air is displaced by liquid. As a consequence of spinning the spin contactor 10, the containment section 14 is spun, in an embodiment. When the spin contactor is rotated, centrifugal force pushes liquid in the spinning containment section 14 in a direction perpendicular to the rotational axis 16, so as to contact the particulates therein. The centrifugal force is determined by the equation F=m [symbol] ²r where F is the centrifugal force, m is the mass of the liquid spinning, [symbol] is the rotation rate and r is the radius of the mass of the fluid spinning. The radius of the mass of the fluid is dictated by the inner radius of the contactor 10.

In a cylindrical contactor with a cylindrical wall, the centrifugal force increases only as the rotation rate increases. However, in the disclosed spin contactor with an inverted frustoconical wall 15, the inner radius of the vessel increases with the height of the spin contactor 10 in the main containment section 14 defined by the conical wall 15. Since the centrifugal force increases as the radius increases with the height of the spin contactor 10, the fluid within the frustoconical containment section 14 will be propelled to rise within the spin contactor 10. The fluid in the spin contactor contacts the particulates therein, thus fluidizing the particulates. The particulates contacting the fluid impart a physical or chemical transformation to the fluid composition. For example, material may be scavenged from the fluid, desorbed into the fluid, or reactant(s) in the fluid may be catalytically converted to product(s). The treated or transformed fluid exits the main containment section 14 through the containment outlet 26 into the top section 18. The upward fluid movement eventually urges the treated fluid in the top section 18 out the fluid discharge outlet(s) 22 in the top section while the particulates are retained in the spin contactor 10.

The conical main containment section 14 is truncated at the vertex of the cone to provide a frustum. Truncation provides a fluid inlet 24 which minimizes the pressure drop through the lower particulate separator 12. The fluid inlet 24 must be sized to draw an adequate flow rate through the spin contactor 10 sufficient to levitate the largest particles in the spin contactor. Sizing of the fluid inlet 24 should also consider the pressure drop imposed by the lower particulate separator 12. In our testing, we have found the fluid inlet 24 having an inner diameter of about ¼ to ⅓ the inner diameter of a base of the cone defined by the conical wall 15 has been adequate to achieve these considerations. The base of the cone defined by the conical wall 15 may also define the containment outlet 26 in FIG. 1.

At a given value of w, pressure drop in the contactor 10 generated by obstruction of the upper and lower particulate separators 28, 12 and general viscosity effects limit the flow rate through the spin contactor 10. Solids loading is defined as the ratio of the mass of solid particulates to the sum of the mass of solid particulates and fluid in the containment section. The solids loading will depend on the particular application of the spin contactor. The solids loading should be sufficiently low to allow fluidization of the particles in the containment section while the contactor is spinning. Notably, when the solids loading is less than about 5 wt % to about 20 wt %, the viscosity of the native diluent is not very sensitive to the levels of solids. The flow of liquid is from the bottom to the top of the spin contactor. This flow levitates the particles in the fluid. At these loading levels, viscosity of the solution will not promote pinning the particulate to the upper particulate separator 28 and still promote sufficient reaction, adsorption or desorption rate.

The shape of the spin contactor is important. Preferably, flat areas or horizontal ledges on the interior walls are to be avoided because they provide settling points for the particles. When an active ingredient settles out, mass transfer to the particle is reduced and these areas may generate dead zones. Therefore, it has been found that conical transitions along the sides of the wall of the containment section may be preferred, so levitated particles can continue to fall to lower regions of the containment section if not rising and freely circulate therein.

In the majority of applications, the particulate material in the containment section will have a particle size distribution (PSD) that is not monodisperse. The conical wall 15 of the main containment section 14 will generate a gradient of fluid velocities as the diameter of the containment section increases with height. This gradient of fluid velocities allows for the levitation of the entire range of the PSD. The particulates may have an average particle size of about 1 to about 3000 microns, typically about 10 to about 500 microns, suitably about 10 to about 150 microns, or preferably about 30 to about 150 microns. It is also envisioned that the containment section 11 alternatively has decreasing internal radius with height in which centrifugal force would increase from top to bottom.

In the ideal case, a sufficient amount of particulate active ingredient (scavenger or catalyst) is desired to complete the kinetic transformation in the spin contactor of a given volume of the containment section 11 during the time necessary to transport the fluid through the spin contactor 10. That is to say, the feed within the spin contactor is completely exchanged in a given unit of time required to move 1 bed volume through the spin contactor. Through routine experimentation the rotation rates for a particular size of spin contactor and fluid being processed can be optimized. It is envisioned that in one embodiment the spin contactor 10 may be in downstream communication with an upstream reactor or an adsorption vessel, so the spin contactor 10 may provide polishing treatment of the fluid.

In order to avoid a high pressure drop across lower particulate separator 12, the rotation rate [symbol] should be fast enough to levitate the particulates above lower particulate separator 12, so that the particulates become fluidized and do not form a packed bed on the lower particulate separator 12. Similarly, in order to avoid a high pressure drop across upper particulate separator 28, the rotation rate [symbol] should be slow enough such that the levitated particulates remain fluidized in containment section 14 but do not form a packed bed against upper particulate separator 28. A rotation rate of about 30 to about 250 rotations per minute, preferably about 50 to about 200 rotations per minute were found to be suitable.

In a purely conical or frustoconical profile, the maximum flow due to centrifugal force will be at the maximum diameter of the conical body. The result is that the maximum flow moves up the side of the conical wall 15 as shown by arrow 32. The particles will therefore be at a higher concentration along the conical wall 15 of the main containment section 14. This could lead to an uneven distribution of particles within the containment section 11 which could lead to lower conversion or adsorption efficiencies.

This effect can be minimized by several approaches that may be used individually or in combination. The effect can be minimized operationally by rotating the spin contactor 10 at a rotational velocity sufficient to disperse or fluidize the particles within the spin contactor but insufficient to cause the particles to gravitate or channel against the conical wall 15.

The spin contactor 10 can be configured to minimize aggregation of particulate along the conical wall 15 by several ways. First, a cylindrical top section 18 above the main containment section 14 as shown in FIG. 1 is configured to have the effect of straightening the upward flow. In FIG. 1, the containment section 11 has a profile comprising a combination of conical and cylindrical sections. The overall effect of the cylindrically configured top section 18 is that the flow in the conical main containment section 14 is also more parallel to the axis of rotation shown by arrow 34 as opposed to along the conical wall shown by arrow 32. At the top of the cylindrical top section 18 above the partition, the maximum flow will be near the outer wall 21 due to the location of the fluid discharge outlets 22. However, at the bottom of the top section 18 below the partition 23, the flow will be closer to the central longitudinal axis 16 of the spin contactor 10.

Second, the fluid outlet 29 could be configured to further straighten flow even more deliberately by locating the fluid outlet only in the center of the partition 23 as shown in FIG. 1. This arrangement pulls liquid upward from the center of the spin contactor 10. The fluid outlet 29 through which fluid exits the containment section 11 is centrally disposed. Fluid must exit the containment section 11 centrally at the top. The partition 23 around the fluid outlet 29 is impermeable to fluid flow tending to straighten fluid flow in the containment section 11.

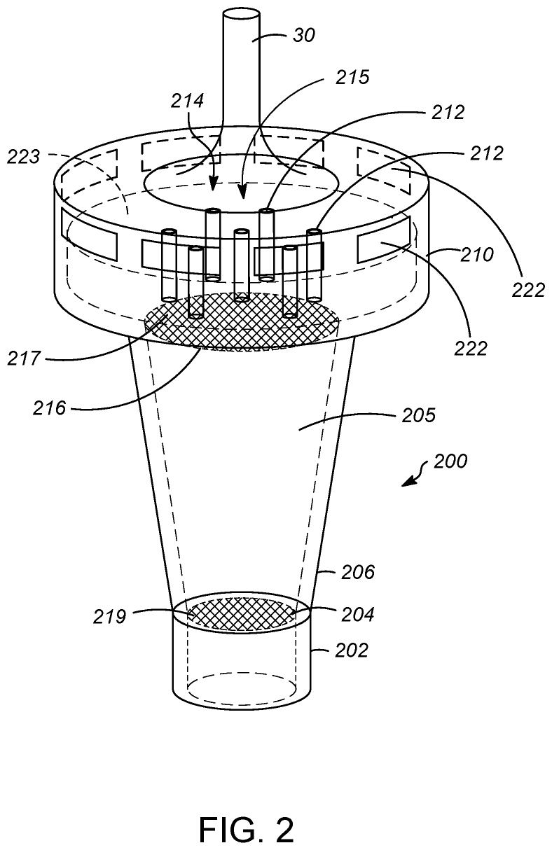

Third, fluid flow can be straightened by installing a flow straightener 214 into the spin contactor as shown in FIG. 2 which is an alternative embodiment to FIG. 1. The embodiment of FIG. 2 only has a conical containment section 205 with a fluid inlet 204 and a fluid outlet 216 at the bottom and top of the conical containment section, respectively. A cylindrical top section 210 and a cylindrical bottom section 202 are not part of the containment section 205 as in the embodiment depicted in FIG. 1 because the upper particulate separator 217 and the lower particulate separator 219 constrain particulates just to the conical containment section 205. The cylindrical top section tends to straighten flow just as in the embodiment of FIG. 1 even though the top section 210 is not part of the containment section 205. The top section 210 additionally has a flow straightener 214 comprising vertical outlet tubes 212 disposed above the containment section 205 in the top section 210. The lower particulate separator 219 is in the fluid inlet 204. It is envisioned that the flow straightener 214 could also be located in the containment section 205 for example in the top section 210 if the top section had the construction of the embodiment of FIG. 1.

The flow straightener 214 comprising outlet tubes 212 is disposed above the upper particulate separator 217, so the particles do not accumulate above the flow straightener. The flow straightener 214 is not shown in phantom, so it is better visualized. The inlets of the outlet tubes 212 are above the upper particulate separator 217 and the outlets of the outlet tubes 212 can communicate through the partition 223 which comprises a tube sheet. The flow of the fluid through the outlet tubes 212 pulls the fluid up from the conical containment section 205 of the spin contactor 200. Hence, in the conical containment section 205 below the outlet tubes 212, the flow is more purely vertical. As shown in FIG. 2, the fluid outlet tubes 212 can comprise an array 215 of vertical tubes 212 or other outlets positioned in the top section 210 of the spin contactor 200 above fluid outlet 216 of the conical main containment section 205. The lateral flow in the top section 210 above the flow straightener 214 is still present as the liquid is expelled from the spin contactor through fluid discharge outlets 222, but below the flow straightener, the fluid flow is generally vertical.

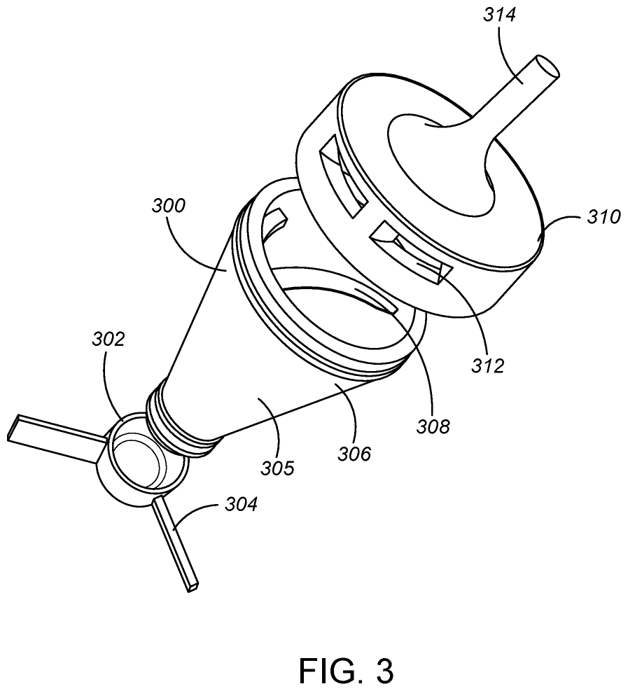

Fourth, baffles or other turbulence inducing structures may be added to the inner wall of the containment section. FIG. 3 shows a spin contactor 300 with a frustoconical main containment section 306 containing internal baffles 308 that are used to urge movement of fluid in the containment section 306 away from the conical wall 305. The internal baffles 308 move the liquid from the wall to the interior of the main containment section 306. This movement mixes the contents of the main containment section 306 leading to a more uniform distribution of particles laterally in the containment section. The top section 310 has upper discharge outlets 312 for discharging treated liquid from the contactor 300 and a shaft 314 that can be connected to a coupling that is connected to a motor for turning or spinning the spin contactor 300. The spin contactor 300 has a bottom section 302 having external blades 304 that can be used to stir a fluid outside of the spin contactor. External blades 304 may be extended from any outer surface of the spin contactor 300. In one embodiment, a bottom assembly of external blades 304 will aid in agitation of the contents of a vessel in which the spin contactor is spun. The external blades 304 may attach to other parts of the spin contactor 300 as long as the blades are positioned to effectively stir the liquid. The external blades 304 are not essential to the operation of the spin contactor but are of overall usefulness.

External blades 304 allow elimination of separate stirring equipment. These blades may allow the user to agitate the fluid before the fluid is charged through the spin contactor. In general, such external blades can extend significantly below the bottom inlet of the spin contactor.

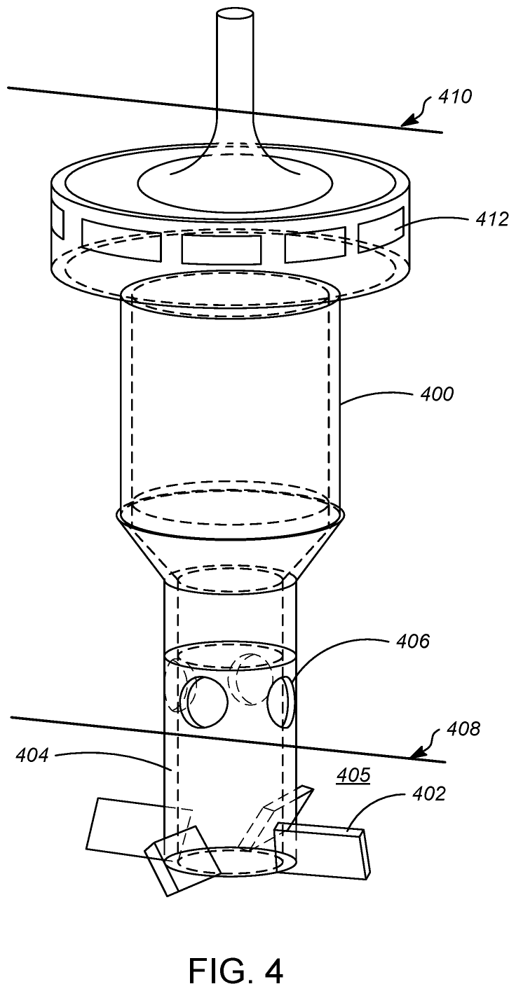

FIG. 4 provides an embodiment of the spin contactor 400 with external blades 402 located on a lower section 404 below a plurality of fluid inlets 406. Since it possible that users will need to agitate fluid 405 during a step before they want to contact particulate with the fluid, the design of the spin filter external blades need to extend significantly below the fluid inlet 406, so just the blades are below fluid level. Partially submerging the spin contactor 400 down to the lower fluid level indicated by 408 will allow the spinning spin contactor 400 just to agitate the fluid. The upper fluid level is indicated by 410 when the spin contactor 400 is completely submerged in the fluid 405. Upon spinning during submersion, fluid 405 will be drawn into the spin contactor 400 and out a fluid outlet 412. It can be seen the fluid 405 may be drawn into fluid inlets 406 from the same volume into which treated fluid is discharged from outlets 412. It is also envisioned that the spin contactor 400 may discharge treated fluid into a different volume of fluid (not shown) from which it is drawn.

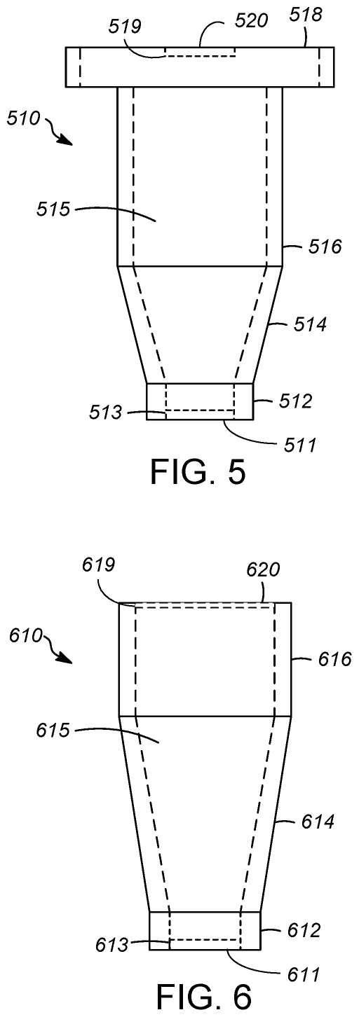

FIGS. 5-8 show several embodiments of different containment sections. FIG. 5 shows containment section 510 having a cylindrical bottom section 512, a cylindrical top section 518, and a main containment section 515 having a lower conical section 514 and an upper cylindrical section 516. The cylindrical top section 518 has one or more fluid outlets 520 and the bottom section 512 has one or more inlets 511. A lower particulate separator 513 may be attached at the bottom of cylindrical bottom section 512 which may have a minimal height provided that there is a sufficient height for the lower particulate separator 513 to be attached to bottom section 512. The top section 518 is also provided with an upper particulate separator 519.

FIG. 6 shows a containment section 610 with a majority of the height of the main containment section 615 occupied by a lower conical section 614. The containment section 610 has a cylindrical bottom section 612 and the main containment section 615 having the lower conical section 614 and an upper cylindrical section 616 with the fluid outlet 620 therein. The conical section 614 is proportionally longer than conical section 514 in FIG. 1. The bottom section 612 has one or more fluid inlets 611 and is further provided with a lower particulate separator 613. The containment section 610 has no top section 618 as the upper particulate separator 619 is at the fluid outlet 620 in the top of the main containment section 615.

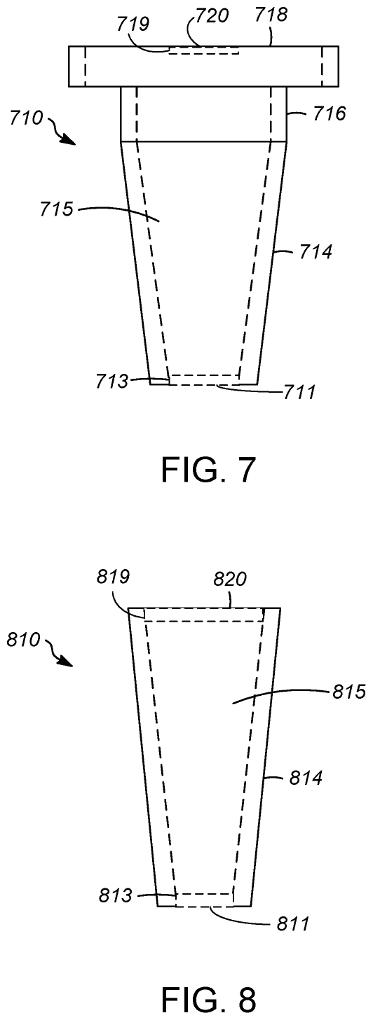

FIG. 7 shows a containment section 710 that has a predominance of the height of the main containment section 715 occupied by a lower conical section 714. A predominance means greater than about 60%, 70%, 75%, or 80%, herein. The top section 718 has one or more fluid outlets 720. A bottom of the conical section 712 is provided with one or more fluid inlet(s) 711 at which is provided a lower particulate separator 713. A short upper cylindrical section 716 is above the lower conical section 714. The top section 718 is also provided with a upper particulate separator 719. The containment section 710 includes no bottom section because the particulate separator 719 is in the lower conical section 714.

As shown in FIGS. 5-7, the spin contactor may have about 60-90% of a height of the main containment section 515, 615, 715 comprising the upper conical section 514, 614, 714 with a conical profile and about 10-40% of the height of the main containment section comprising the upper cylindrical section 516, 616, 716 with a cylindrical profile.

FIG. 8 shows a containment section 810 having no top section or bottom section and a long conical section 814 comprising 100% of the main containment section 815. One or more fluid inlets 811 is in the bottom of the conical section 814. A lower particulate separator 813 is in the fluid inlet 811. One or more fluid outlets 820 is in the top of the main containment section 815. The top of the main containment section 815 is provided with a upper particulate separator 819.

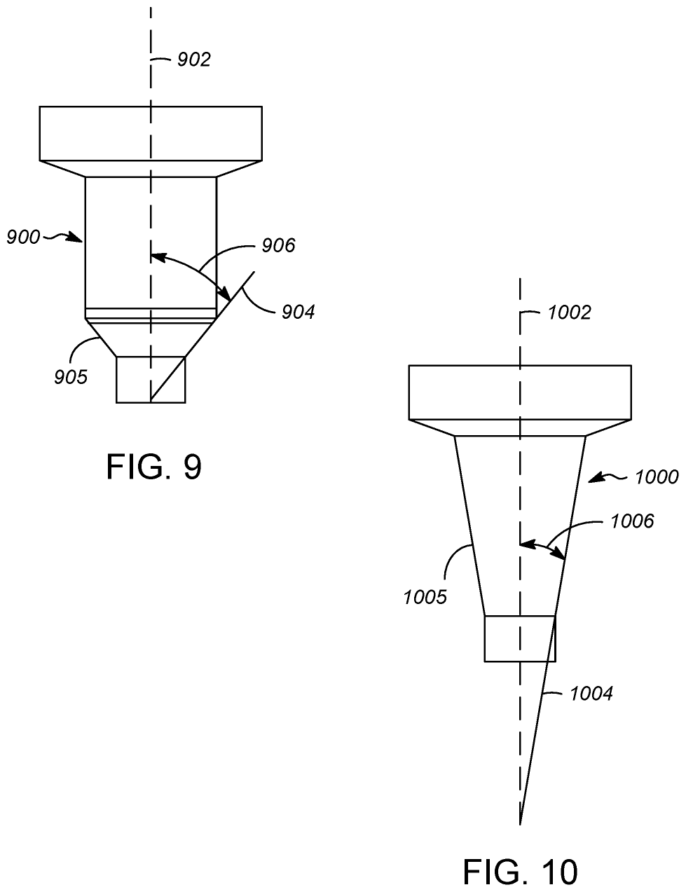

FIG. 9 shows a containment section 900, and FIG. 10 shows a containment section 1000. Containment section 900 has a central longitudinal axis 902 and a cone angle 906 defined by central longitudinal axis 902 and line 904 which is congruent with the conical wall 905 of the main containment section 900. Containment section 1000 has a central longitudinal axis 1002 and a cone angle 1006 defined by central axis 1002 and line 1004 which is congruent with the conical wall 1005 of the main containment section 1000. It may be seen that the cone angle 1006 is smaller than the cone angle 906 with respect to the central longitudinal axis 1002 and 902, respectively. The cone angle of the wall 905, 1005 of the conical main containment section 900, 1000 will affect the flow properties of the fluid in the portion. Steeper cone angles will tend to concentrate the active ingredients and act more like an efficient column system with higher length-to-diameter ratios. However, a cone angle that is too steep will result in a greater pressure drop and shorter contact times for a given overall length. In general, the spin contactor having the smaller angle such as spin contactor 1000 is preferred. In experimental use, a cone angle from about 15 to about 45 degrees measured from a central longitudinal axis 902, 1002 of the containment section 900, 1000, respectively, is preferred.

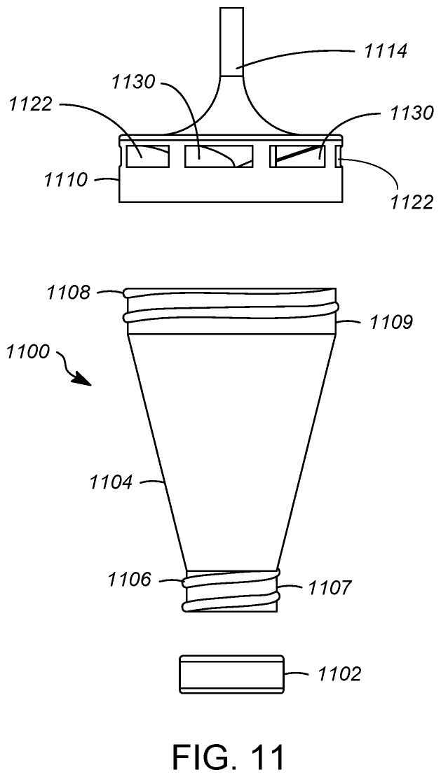

FIG. 11 is an exploded view of a spin contactor 1100 having a bottom cylindrical section 1102 that attaches to the main containment section 1104 at screw connection 1106 comprising external threads on a cylindrical fluid inlet 1107. Internal threads in the bottom cylindrical section 1102 mate with external threads on the fluid inlet 1107. A lower particulate separator that is not visible may be provided in the fluid inlet 1107 or in the bottom section 1102. The top section 1110 attaches to the containment section 1104 by a screw connection 1108 provided by an externally threaded cylindrical extension comprising a fluid outlet 1109 that mates with internal threads in the top section 1110. An upper particulate separator that is not visible may be located within the fluid outlet 1109 or in the top section 1110.

FIG. 11 shows discharge outlets 1122 for treated liquid to exit the top section 1110 of the spin contactor 1100. In this embodiment, the upper particulate separator (not shown) would be located below the fluid outlets 1122 and perhaps the top section 1110 on the containment section 1104. Discharge vanes 1130 in the top section 1110 direct spinning liquid in the top section to horizontally slotted discharge outlets 1122 from which treated liquid is discharged laterally from the top section 1110 by centrifugal force. Discharge vanes 1130 may be molded into the top section 1110. A shaft 1114 protruding from the top of the top section 1110 may be coupled to a motor that is employed to spin the spin contactor 1100. An associated coupling bushing may be employed to couple the shaft 1114 to a shaft of the motor as well.

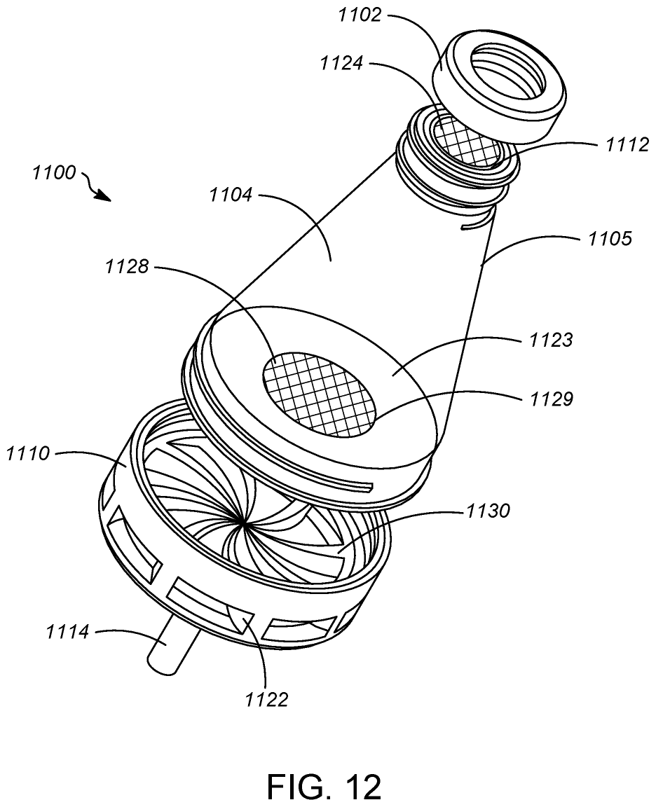

FIG. 12 depicts the spin contactor 1100 of FIG. 11 in perspective and upside down. FIG. 12 depicts the bottom section 1102, the containment section 1104, the top section 1110, discharge outlets 1122, the shaft 1114 and the discharge vanes 1130. A lower particulate separator 1124 is disposed in a fluid inlet 1112. An upper particulate separator 1128 is disposed in a fluid outlet 1129 provided in an impermeable partition 1123 in a base defined by a conical wall 1105 of the containment section 1104. It is envisioned that the containment section 1104 section may be filled with particulate and equipped with the upper particulate separator 1128 and the lower particulate separator 1124 to constrain the particulate in the containment section 1104. The filled containment section 1104 can be supplied to an operator who has the spinning equipment including the bottom section 1102 and the top section 1110 to which the containment section 1104 is installed to enable operation of the spin contactor 1100. Fluid impermeable caps (not shown) may be installed on the particulate separators 1124, 11128 to prevent fluid from spoiling particulate material during transport and handling.

In one embodiment is provided a spin contactor for contacting a particulate with a fluid, said spin contactor comprising a containment section containing said particulate and having a conical side wall, a fluid inlet, and a fluid outlet. The spin contactor comprises an upper particulate separator and a lower particulate separator. The spin contactor has a shaft to be operatively coupled to a motor for spinning the spin contactor whereby the fluid is drawn upward through the lower fluid inlet to contact the particulate in the containment section and then is expelled through the upper fluid outlet. The fluid outlet may comprise one or more openings disposed above the upper particulate separator. The containment section may further comprise a cylindrical wall above or below, or both above and below the partially conical wall. The upper and lower particulate separators can comprise a screen, a fabric, a frit, or any other material that will allow the fluid and its desired components to pass into and out of the containment section, while retaining the particulates within the containment section. The upper particulate separator may comprise a screen positioned above the containment section and configured to constrain particles to remain within the containment section of the spin contactor. The lower particulate separator may comprise a screen positioned below the containment section at or near the bottom of the spin contactor and configured to constrain particles to remain within the containment section of the spin contactor. The spin contactor may comprise a non-reactive material disposed within the spin contactor. The spin contactor may have about 60-90% of a height of the containment section having a conical profile and about 10-40% of the height of the containment section having a cylindrical profile. In the embodiment of FIG. 4, close to 100% of the height of the spin contactor is a conical section. There may be a set of external blades extending from the spin contactor. The set of external blades extending from the spin contactor may be below the lower fluid inlet of said spin contactor The spin contactor may further comprise one or more internal baffles in the containment section of the spin contactor. The spin contactor may further comprise a flow straightener disposed within the containment section of the spin contactor The spin contactor may comprise an opening in a bottom of the spin contactor having an inner diameter from about ¼ to about ⅓ of the inner diameter of the cone base. The at least partially conical wall of the containment section may have a cone angle from about 15 to about 45 degrees measured from a vertical axis of the spin contactor. The containment section with a partially conical wall may be a frustocone. The spin contactor may be in downstream communication with a reactor or adsorption vessel.

In another embodiment is provided a process of treating a fluid composition, comprising charging the fluid composition to a spin contactor comprising a conical wall that defines a volume containing particulates, rotating the spin contactor at a velocity sufficient to fluidize the particulates, contacting the fluid composition with the fluidized particulates to effect a physical or chemical transformation of the fluid composition, and discharging the transformed fluid composition from the spin contactor while retaining said fluidized particulates in the spin contactor. There may further be a particulate separator at or near a top of the spin contactor that constrains said particulates to remain within said spin contactor. The particulates have an average particle size of 1-3000 microns, 10-500 microns, 10-150 microns, or 30-150 microns. The spin contactor is rotated at a sufficient velocity so that particulates within the spin contactor are dispersed wherein said sufficient velocity is less than a maximum velocity at which particles are forced against the walls of the spin contactor. The spin contactor may be positioned in a vessel containing the fluid composition. In the process, the mixture enters the spin contactor through an opening at or near a bottom of the spin contactor and exits through the top. The spin contactor may be partially or completely submerged into a liquid in a vessel. The process may further comprise generating a gradient of particle size distribution of the particulate in a containment section. The flow may be straightened through the top of the spin contactor. It is anticipated that a fluid after flowing through the spin contactor will exit but then may return to the spin contactor to be further treated or reacted.

1. A spin contactor for contacting a particulate with a fluid, said spin contactor comprising:
a containment section comprising a conical wall configured to contain particulate;
a fluid inlet;
a fluid outlet;
a first particulate separator, and
a second particulate separator;
whereby said containment section is adapted to be spun and draw fluid through said fluid inlet to contact said particulate in said containment section and expel fluid through said fluid outlet.

2. The spin contactor of claim 1 further comprising a discharge outlet comprising one or more openings disposed in a cover above said second particulate separator.

3. The spin contactor of claim 1 wherein said containment section further comprises a cylindrical wall above or below, or both above and below said conical wall.

4. The spin contactor of claim 1 wherein said first particulate separator is positioned below said containment section and configured to constrain particles to remain within said containment section of said spin contactor.

5. The spin contactor of claim 1 wherein said second particulate separator is positioned above said containment section and configured to constrain particles to remain within said containment section of said spin contactor.

6. The spin contactor of claim 1 wherein about 60 to about 90% of a height of said containment section has a conical profile and about 10 to about 40% of said height of said containment section has a cylindrical profile.

7. The spin contactor of claim 1 further comprising a set of external blades extending from said spin contactor.

8. The spin contactor of claim 1 further comprising a set of external blades extending from said spin contactor wherein said external blades are positioned below said lower fluid inlet of said spin contactor.

9. The spin contactor of claim 1 further comprising one or more internal baffles in the containment section of said spin contactor.

10. The spin contactor of claim 1 further comprising a flow straightener disposed proximate to the fluid outlet.

11. The spin contactor of claim 1 wherein the fluid inlet has an inner diameter that is about ¼ to about ⅓ of the inner diameter of a base of the cone defined by the conical wall.

12. The spin contactor wherein said conical wall has a cone angle from about 15 to about 45 degrees measured from a longitudinal axis of said spin contactor.

13. The spin contactor of claim 1 comprising particulate in the containment section.

14. A process for treating a fluid composition, comprising charging said fluid composition to a spin contactor comprising a conical wall that defines a volume for containing particulate, rotating said spin contactor at a velocity sufficient to fluidize said particulate and contacting the fluid composition with the fluidized particulate to effect a physical or chemical transformation of said fluid composition and discharging the transformed fluid composition from said spin contactor while retaining said fluidized particulate in said spin contactor.

15. The process of claim 14 wherein a particulate separator near a top of said spin contactor constrains said particulates to remain within said spin contactor.

16. The process of claim 14 wherein said spin contactor is rotated at a sufficient velocity so that particles within said spin contactor are fluidized wherein said sufficient velocity is less than a maximum velocity at which particles pin against the said particulate separator.

17. The process of claim 14 wherein said spin contactor is positioned in a vessel containing said fluid composition.

18. The process of claim 14 wherein said fluid composition enters said spin contactor through a fluid inlet near a bottom of said spin contactor and exits through a fluid outlet near a top of said spin contactor.

19. The process of claim 14 further comprising straightening the flow of the fluid composition through the fluid outlet of the spin contactor.

20. A spin contactor for contacting a particulate with a fluid, said spin contactor comprising:
a containment section for containing said particulate,
a fluid inlet,
a fluid outlet;
said containment section comprising a conical wall;
a first particulate separator near the fluid inlet,
a second particulate separator near the fluid outlet; and
a shaft to be operatively coupled to a motor for spinning said spin contactor; whereby said fluid is drawn through said fluid inlet to contact said particulate in said containment section and then is expelled through said fluid outlet.

21. The spin contactor of claim 20 wherein said first particulate separator is at a fluid inlet.

22. The spin contactor of claim 20 wherein said second particulate separator is at a fluid outlet of said containment section.
